(19) United States
(12) Patent Application Publication
(10) Pub. No.: US 2005/0079010 A1
(43) Pub. Date: Apr. 14, 2005

(54) Mechanical connector

(76) Inventor: J. Patrick Droppleman, Libertyville, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/685,255

(22) Filed: Oct. 14, 2003

(51) Int. Cl. F16D 1/00

(52) U.S. Cl. 403/348

(57) ABSTRACT

A mechanical connector includes a male portion and a female portion, that are adapted to quickly and easily connect and disconnect to and from each other while providing for a secure and tight-fit connection that is able to pass lateral force there through. The male portion includes a base having a mating surface, a first locking member having one or more outwardly protruding lugs, and a guide rod. The female portion includes a base having a mating surface and an aperture, a second locking member in the form of a cavity, and a bore adapted to accept the guide rod. Rotation of the male and female portions relative to each other causes the first and second locking members to securely engage, which forces the bases of the male and the female portions together and to be locked in place to form the secure connection.

### TECHNICAL FIELD

The present invention relates generally to a mechanical connector mechanism and, more particularly, to a quick connector mechanism adapted to enable two elements to be quickly and easily connected together to perform a variety of functions.

### BACKGROUND

Mechanical connectors are well known in the art, and are typically used to connect two mating portions together. Some connectors are specifically designed to enable quick and/or easy connection and disconnection. Pneumatic devices, for example, utilize a bearing/groove type of mating connection for quick connection of a supply device to a hose. In some cases, pneumatic device connectors include a male portion having an annular groove located around a protrusion, and a female portion having a mating aperture for the protrusion, a sleeve portion, an engaging member, and a spring. To connect the female and male portions together, the user forces the sleeve portion, which is biased by the spring, to a return position thereby allowing the engaging member to recede from the mating aperture. Once the engaging member is recessed, the user may insert the protrusion into the female aperture and release the sleeve, thereby allowing the engaging member to engage the groove. To disconnect the male and female portions, the user may reverse the order of the connection process.

Other quick connectors such as that disclosed in U.S. Pat. No. 692,795, include a male portion having a plurality of outwardly extending tabs located radially around a central protrusion, a female portion having corresponding mating apertures for the tabs, and a biasing spring or gasket. This type of biased connector is often used in the housing and connection of electrical fuses and in the attachment of adaptors to power tools, and the like. During engagement, the user forces the male portion into the female portion, thereby overcoming the bias of a spring. As the central protrusion is inserted into the female portion, and the tabs engage with the apertures, the user twists the male and female portions relative to each other, thereby locking the tabs into the apertures. To disconnect the device, the user may reverse the order of the connection process.

While these types of quick connectors typically work well for their intended purpose, these and other connectors have limitations and problems that make their adaptation for other uses difficult, if not impossible. For example, the bearing/groove type connectors used with pneumatic devices generally require a knurled or other rough surface on the exterior of the connector to enable the user to move the biased sleeve portion during connection and disconnection of the connector, thereby eliminating the possibility of an esthetically pleasing smooth contiguous surface. Similarly, the bearing/groove type connectors give the male and female portions the ability to rotate relative to each other during engagement of the male and female portions. Such a feature may be ideal for connecting pneumatic hoses, and the like, but is not desirable when a stiff and solid connection is desired.

Still further, biased type connectors, which by their very nature operate on the principle that the bias ensures continued engagement of the male and female portions, are not sturdy enough and cannot be used in many high stress or tension environments. More specifically, because the bias ensures continued engagement of the male and female portions, any stress or tension greater than the compression force provided by the bias member, makes the connector vulnerable to disconnection and failure. Furthermore, even though some quick connectors may be able to withstand certain amounts of stress and tension, none of the above mentioned connectors is able to translate a large amount of force laterally through the connection device.

### SUMMARY OF THE DISCLOSURE

A mechanical connection device includes male and female connection members that can be quickly connected and disconnected, while providing appropriate structure to enable the transference of a large amount of force between or through the male and female connection members. In one embodiment, the connection device is esthetically pleasing, as it includes a contiguous surface between the male and female connection members so as to make the point of connection camouflaged.

The connector includes first and second portions which, when engaged and rotated relative to each other, secure and create a sturdy mechanical connection. The first portion may include a first locking member having a plurality of outwardly protruding lugs and the second portion may include a second locking member having a cavity. During connection, the user engages the first locking member with the second locking member, inserts the lugs into the cavity, and rotates the first and second portions relative to each other, causing the lugs to engage the cavity, thereby connecting the two portions.

If desired, the first locking member may include a guide rod that is sized to fit into a bore on the second locking member. During connection, the user can generally align the first and second portions using the guide rod. More specifically, the user can haphazardly place the guide rod in the general proximity of the cavity of the second portion, engage the guide rod with the cavity and hence the bore without great agility, effort or dexterity. Thereafter, the user can guide the first and second locking members together by sliding the guide rod into the bore, which causes the first and second connector portions to align respectively when the first locking member meets the cavity. To complete the connection, the user engages the first locking member with the second locking member by inserting the lugs into the cavity, and rotates the first and second portions relative to each other to cause surfaces of the lugs to positively engage with surfaces of the cavity, thereby connecting the first and second portions together.

### BRIEF DESCRIPTION OF THE DRAWINGS

FIG. 1 is an isometric view of one embodiment of a mechanical connector in a disconnected position;

FIG. 2 is an isometric view of the mechanical connector in FIG. 1 in a connected position;

FIG. 3 is an isometric view of a male portion of the connector of FIG. 1;

FIG. 4 is an isometric view of a female portion of the connector of FIG. 1;

FIG. 5 is a top plan view of the male portion of FIG. 3;

FIG. 6 is a top plan view of the female portion of FIG. 4;

FIG. 7 is an isometric view of an alternate embodiment of the male portion of FIG. 3 having a seal member;

FIG. 8 is an isometric view of another alternate embodiment of the male portion of FIG. 3 having a seal member;

FIG. 9 is an isometric view of an alternate embodiment of the female portion of FIG. 4 having a seal member;

FIG. 10 is an isometric view of an alternate embodiment of the female portion of FIG. 4 having a seal member;

FIG. 11 is an isometric view of an alternate embodiment of the female portion of FIG. 4 having an angled surface;

FIG. 12 is an isometric view of an alternate embodiment of the mechanical connector in a disconnected position having contoured mating surfaces;

FIG. 13 is an isometric view of an alternate embodiment of a mechanical connector in the disconnected position having a passageway;

FIG. 14 is an isometric view of an alternate embodiment of the mechanical connector having a support sleeve;

FIG. 15 is an isometric view of an alternate embodiment of the mechanical connector of FIG. 1 having fittings;

FIG. 16 is an isometric view of another embodiment of a mechanical connector; and

FIG. 17 is an isometric view of yet another embodiment of a mechanical connector.

While the method and device described herein are susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention as defined by the appended claims.

### DETAILED DESCRIPTION

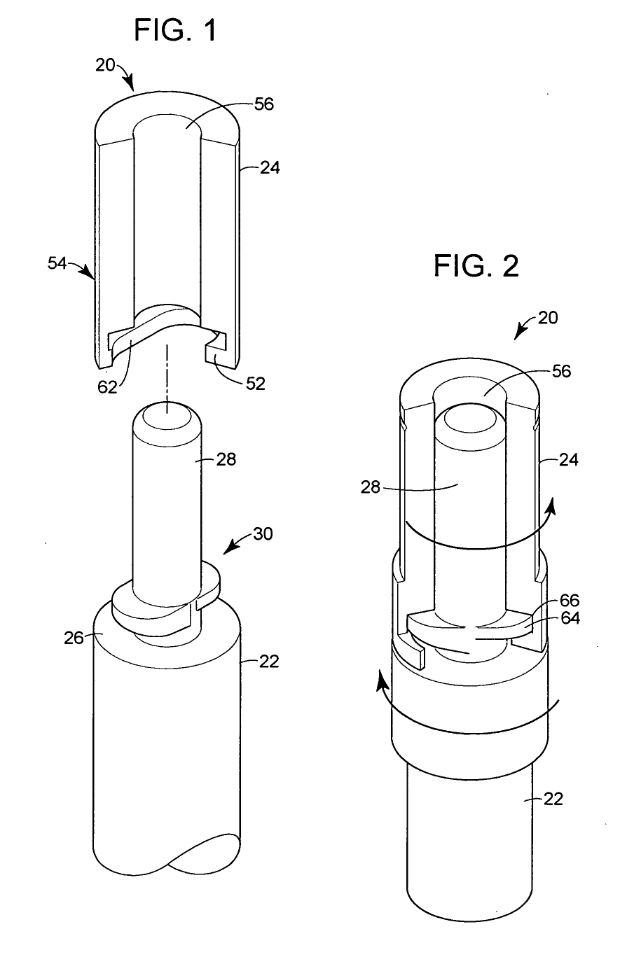

Referring to FIG. 1, a quick connector 20 includes a male portion 22 and a female portion 24. The connector 20, in its most basic utility, is used to connect two members together, wherein the first member is attached to the male portion 22 and the second member is attached to the female portion 24. The first and second members may be part of many different types of devices, apparatus, and objects. For example, the members can be hoses, tubes, rods, shafts, and the like, and more particularly, can be garden hoses, fire hoses, oxygen tubes, broom handles, paint roller handles, golf club shafts, etc., or any other device having two members to be connected together laterally. Of course, the connector 20 is not limited to the uses identified above, but may adapted for any number of other uses.

The connector 20 is intended to operate using a simple insert and twist method to connect the male portion 22 to the female portion 24. More specifically, to connect the male and female portions 22, 24 together, the user inserts the male portion 22 into the female portion 24, as seen in FIG. 1, until the male and female portions 22, 24 are substantially abutting each other, at which point the user rotates the male and female portions 22, 24 relative to each other to force the male and female portions 22, 24 into a fixed engagement with one another, as depicted in FIG. 2.

As illustrated in FIG. 1, the male portion 22 of the connector 20 includes a base 26, a guide rod 28 and a first locking member 30, while the female portion 24 includes a base 52, a locking member 54, and a bore 56.

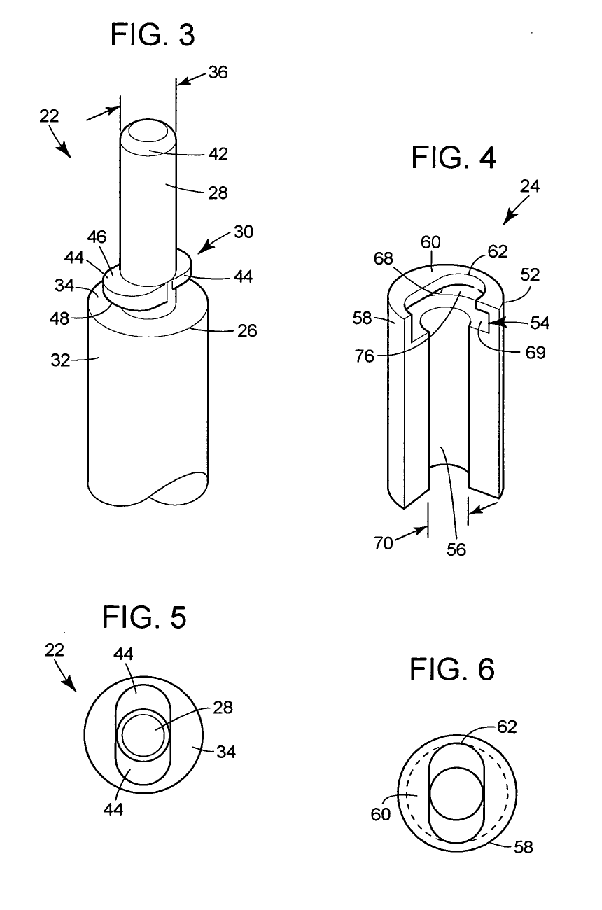

More specifically, as illustrated in FIG. 3, the base 26 of the male portion 22 includes an exterior surface 32 having a generally round profile, and a substantially smooth finish. A mating surface 34 which is generally flat and smooth defines the top of the base 26. As best illustrated in FIG. 3, the guide rod 28 is of a generally cylindrical shape having an outer diameter 36. An annular chamfer 42 may be located at an end on the guide rod 28, opposite the mating surface 34, to aid in the insertion of the guide rod 28 into the female portion 24.

The locking member 30, which may be located towards the base 26 of the guide rod 28, includes one or more lugs 44 protruding radially outwardly from the guide rod 28. The lugs 44 include an upper surface 46 and a lower surface 48, which may be oriented such that the upper surface 46 and the lower surface 48 are not parallel to each other. More specifically, the lower surface 48 of the lugs 44 may be manufactured to create a slanted or semi-spiral surface to allow gradual tightening of the connector 20 during operation, and the upper surface 46 may remain parallel to the mating surface 34 of the base 26. If desired the upper surface 46 may be slanted while the lower surface 48 is flat, or both the upper and lower surfaces 46, 48 may be slanted.

The locking member 30 may form a locking shape created by the lugs 44, the guide rod 28, or a combination thereof. As best illustrated in FIG. 5, the locking shape formed by the lugs 44 may be oval, such that the guide rod 28 is located toward the center of the oval and the lugs 44 are located to either side of the guide rod 28.

The base 52 of the female portion 24, best illustrated in FIG. 4, includes an exterior surface 58, a second mating surface 60 and an aperture 62. As shown in FIGS. 4 and 6, the profile of the exterior surface 58 of the base 52 may be generally round, and the finish may be substantially smooth. The exterior surface 58 of the base 52 may, however, include a great variety of profiles and finishes, and may be adapted to compliment the profile of the male portion 22, or of the base 26 of the male portion 22, as seen in FIG. 1. The second mating surface 60, which defines the bottom of the base 52 as depicted in FIG. 4, may be generally flat and smooth.

The aperture 62 of the base 52 (FIG. 4), which may be generally located toward the center of the base 52 of the female portion 24 is adapted to allow passage of the first locking member 30 into the female portion 24 of the connector 20. More specifically, the aperture 62 (FIG. 6) of the base 52 has a complimentary shape to the locking shape of the first locking member 30, such that the first locking member 30 can pass through the aperture 62.

The bore 56, as depicted in FIG. 4, may be of a generally cylindrical shape having an inner diameter 70 that is adapted to receive the guide rod 28 of the male portion 22 (FIG. 2). The second locking member 54, which may be located in the proximity of base 52, includes a cavity 76 having lug surfaces 68 and 69. The cavity 76 is adapted to receive at least a portion of the first locking member 30, and the lug surfaces 68 and 69 are adapted to engage with the lower surface 48 and the upper surface 46 of the lugs 44. One or both of the lug surfaces 68, 69 may be parallel to the second mating surface 60 of the base 52 of the female portion 24, or may be parallel to the lower surface 48 of the lugs 44. If desired one or both of the lug surfaces 68 and 69 may be slanted or semi-spiral with respect to the surface 60, as best illustrated in FIG. 11. In this case both of the lug surfaces 46 and 48 will generally be flat (i.e. parallel to one another) or slanted.

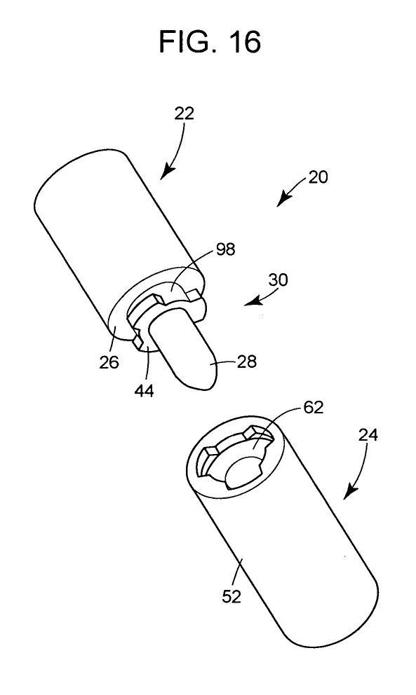

The above exemplary embodiment may include many variations thereof, to achieve and/or create additional or alternative features. For example, the exterior surface 32 of the base 26 is not limited to smooth and round, but may include a great variety of profiles and finishes. The profile of the exterior surface 32 may include, but is not limited to, square, triangular, hexagonal, or oval, and the finish of the exterior surface 32 may include, but is not limited to, knurled, smooth or rough. Also, the locking shape may be any viable shape able to accomplish the intended purpose, including but not limited to, square, rectangular, and triangular, or some complex combination thereof, an example of which is illustrated in FIG. 16.

In operation, the user may insert the guide rod 28 located on the male portion 22 of the connector 20 through the aperture 62 and the cavity 76 into the bore 56 of the female portion 24. This action may be accomplished by placing the bore 56 and the guide rod 28 in the general vicinity of each other without necessarily perfectly aligning the male and female portions 22, 24, as seen in FIG. 1. More specifically, by orienting and bringing the bore 56 and guide rod 28 together, the male and female portions 22, 24 of the connector 20 will axially align without further aid and or alignment from the user. Therefore, the user may quickly and easily axially align the bore 56 and the guide rod 28, and ultimately the male and female portions 22, 24 of the connector 20, without visual contact with connector 20.

Before placing the first locking member 30 into the second locking member 54, (i.e., the lugs 44 into the cavity 76) the user may align the shape of the first locking member 30 of the male portion 22 and the aperture 62 of the female portion 24. More specifically, the user may rotate the guide rod 28 in the bore 56 until the shape of the first locking member 30 of the male portion 22 aligns with the aperture 62 of the female portion 24, thereby allowing the first locking member 30 to penetrate the second mating surface 60 of the female portion 24 and ultimately allowing the first and second locking members 30, 54 to engage.

Once the first and second locking members 30, 54 are aligned, the user may further insert the male portion 22 into the female portion 24 until at least a portion of the first locking member 30 is located within the cavity 76, and until at least a portion of the surfaces 46 or 48 of the lugs 44 is engageable with one of the lugs surface 68 and 69. The lower surface 48 of the lug 44 is engageable with the lug surface 68 if, upon rotation of the male and female portion 22, 24 relative to each other, the lower surface 48 of the lug 44 is able to abut the lug surface 68.

Once one of the surfaces 46 or 48 of the lugs 44 is engageable with the lugs surface 68 or 69, the user may rotate the male and/or the female portions 22, 24 relative to each other. More specifically, by rotating the male and/or the female portion 22, 24 relative to each other, the user forces the male and female portions 22, 24 together, and more particularly, forces the mating surface 34 of the male portion 22 toward the second mating surface 60 of the female portion 24. The user rotates until a tight fit is achieved, i.e., when the distance between bottom and top surfaces 48 and 46 of the lug 44 is equal to the distance between the surfaces 61 and 69 of the aperture 62, at which the point the two connector members are tightly fit together.

In another exemplary embodiment, the shape of the first locking member 30 and the shape of the aperture 62 in the base 52 of the female portion 24 may be adapted to create a tight tolerance between the aperture 62 and the first locking member 30, such that there is limited clearance between an outer surface 64 (FIG. 2) of the lugs 44 and/or the guide rod 28 and an inner surface 66 of the aperture 62 (FIG. 2). Similarly, the shape of the first locking member 30 and the shape of the aperture 62 in the base 52 of the female portion 24 may be adapted to retain the complimentary shapes of the first locking member 30 and aperture 62, while maximizing the contact area between the lower surface 48 of the lugs 44 and a lug surface 68 of the second locking member 54 (FIGS. 3 and 4). More specifically, the shape and size of the first locking member 30 will dictate the size of the surface area of the lower surface 48 of the lugs 44. The complimentary shape and size of the aperture 62 will determine the amount of engageable area of the lower surface 48 of the lugs 44 and the lug surface 68. Therefore, by properly sizing and shaping the first locking member 30 and the aperture 62, the contact area between, for example, the lower surface 48 of the lugs 44 and the lug surface 68 can be maximized during engagement of the connector 20.

In another exemplary embodiment, the user may transfer a lateral force or load from the male portion 22 to the female portion 24 or vice-versa, when these portions are engaged. In particular, when the connector 20 is in the connected position, as shown in FIG. 2, a lateral and/or transverse force may be applied to the female or male portions 24, 22 of the connector 20, and translated to the other connector member while the connector 20 remains connected without failure.

More particularly, as a force is applied to the connector 20, the connector 20 may have a tendency to bend and/or break depending on the magnitude of the force. Several factors including, but not limited to, the increased contact area between the mating surface 34 of the male portion 22 and the second mating surface 60 of the female portion 24, the length and depth of the guide post 28 and the bore 56, and the gap between the outer diameter 36 of the guide post 28 and inner diameter 70 of the bore 56, may increase the strength of the connector 20, and hence improve the ability of the connector 20 to translate force (FIGS. 3 and 4).

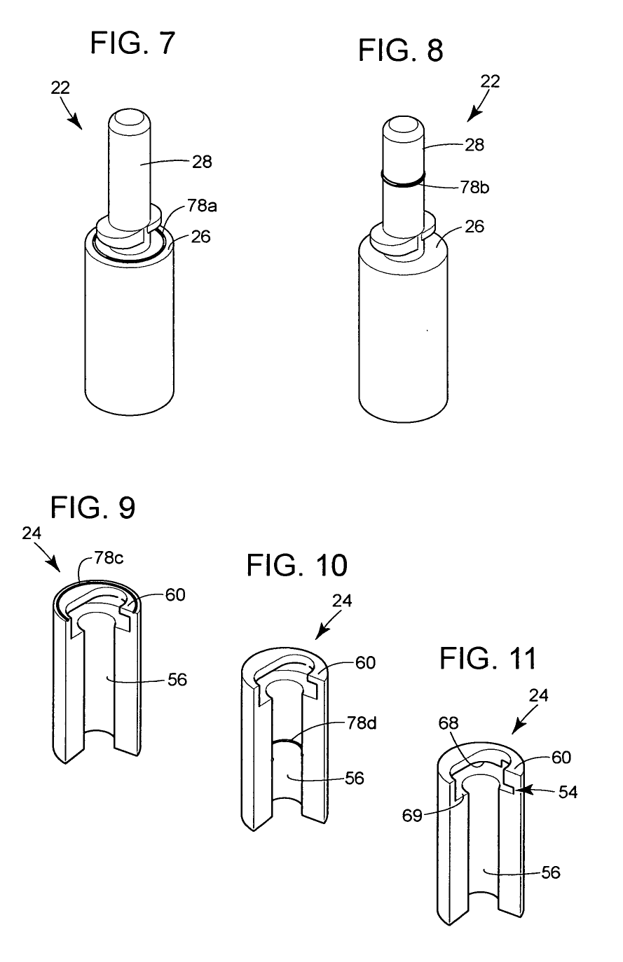

In other exemplary embodiments illustrated in FIGS. 7-10, the connector 20 includes one or more seal members 78 located on the male portion 22 and/or the female portion 24. For efficiency and clarity, the seal members 78 will herein be referenced and described in general as seal members 78, and when referring to a particular one of the seal members 78, as a seal member 78a, 78b, 78c or 78d. More specifically, as depicted in FIG. 7, the male portion 22 of the connector 20 may include a seal member 78a located on the mating surface 34 of the base 26. Additionally or alternatively, a seal member 78b may be located on the guide rod 28, as depicted in FIG. 8. Similarly, as illustrated in FIG. 9, the female portion 24 may include a seal member 78c located on the second mating surface 60 of the base 52 and/or, as depicted in FIG. 10, a seal member 78d may be located in the bore 56. The seal members 78 may be any type of seal adapted to restrict the flow of fluid and/or improve the connection between the male and female portions 22, 24 of the connector 20. The seal members 78 may, include, but are not limited to, O-ring type seals, mating seals, and any other type of seal able to accomplish the intended sealing purpose.

During operation, of these exemplary embodiments, the user may compress one or more of the seal members 78 located on the male and/or female portions 22, 24 to cause a fluid seal between the two members. More specifically, during connection of the connector 20 as shown in FIG. 2, the engagement of the male and female portions 22, 24 may compress the one or more seal members 78 therebetween.

In another exemplary embodiment, the guide rod 28 of the male portion 22 and the bore 56 of the female portion 24, are tightly toleranced. More specifically, the outer diameter 36 of the guide rod 28 and the inner diameter 70 of the bore 56 may be manufactured, such that the movement or clearance between the guide rod 28 and the bore 56 is minimized during engagement of the male and female portions 22, 24. For example, in the instance when the outer diameter of the guide rod 28 is approximately 0.250 inches, the desired distance and tolerance between the inner diameter 70 of the bore 56 and the outer diameter 36 of the guide rod 28 may be in the range of 0.0005^{+0.0002} to 0.0005^{-0.0002}, and more particularly may be 0.0005^{+0.0002/-0.0000}. Similarly, the clearance between the guide rod 28 and the bore 56, regardless of the outer diameter 36 of the guide rod 28 and the inner diameter 70 of the bore 56, may be in the range of 0.0005 to 0.0007, and more particularly may be 0.0005 clearance.

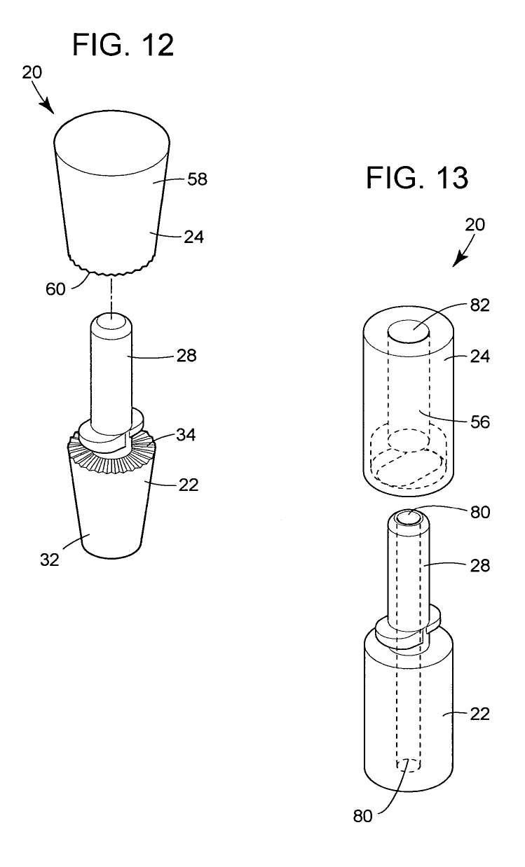

In another exemplary embodiment, as depicted in FIG. 12, the mating surface 34 of the male portion 22 and/or the second mating surface 60 of the female portion 24 may include other surface finishes, contours and materials. For example, the mating surface 34 and/or the second mating surface 60 may include ridges or other non-smooth surfaces to create friction and enhance the connection of the male and female portions 22, 24. Similarly, the mating surface 34 and/or the second mating surface 60 may include materials that may enhance the connection of the male and female portions 22, 24. More specifically, the mating surface 34 and/or the second mating surface 60 may include a resilient material such as rubber or latex, or a plastic material such as polyethylene, polypropylene, polystyrene, etc.

FIG. 12 also depicts one example of the contiguous surface as described earlier, wherein in this example, the female portion 24 has a frusto-conical shape that is continued on the male portion 22, thereby creating a contiguous surface between the exterior surface 58 of the female portion 24 and the exterior surface 32 the male portion 22 when the male and female portions 22, 24 are connected together. More specifically, as oriented in FIG. 12, the outer diameter of the female portion 24 decreases from the top of the female portion 24 to the bottom of the female portion 24. Similarly, the outer diameter of the top of the male portion 22, which is substantially similar or equal to the outer diameter of the bottom of the female portion 24, decreases toward the bottom of the male portion 22.

In another exemplary embodiment, the connector 20 may include a fluid passageway between the male and the female portions 22, 24. More specifically, the connector 20 may be adapted to allow for the transfer of fluid through the connector 20 from the male portion 22 to the female portion 24 or vice-versa. For example, as seen in FIG. 13, the male portion 22 of the connector 20 may include a hollow passage 80 and, the female portion 24 of the connector 20 may include a hollow portion 82 therethrough, which may be an extension of the bore 56. This embodiment enables the passing of fluid through the connector 20 when the male and female portions are engaged and may be deliverable when, for example, the connector 20 is used in a fluid delivery system. The seals 78 illustrated in FIGS. 7-10 may also be advantageously used in this embodiment. The type of fluids with which the connector 20 may be used may vary greatly and may range from gaseous to liquidous form, or a combination thereof. For example, the fluid may include a gas such as Oxygen, Nitrogen, Air, Hydrogen, Helium, etc., or a liquid, such as water, fire retardant, etc.

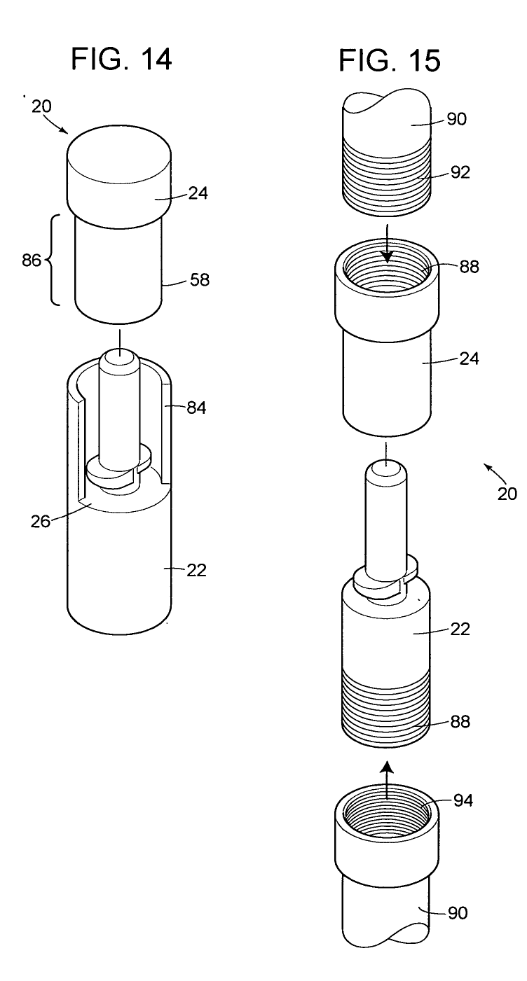

In another exemplary embodiment depicted in FIG. 14, the connector 20 includes a support sleeve 84 located on the male and/or the female portion 22, 24. More specifically, the connector 20 may include a support sleeve 84 extending past the base 26, 52 of the male and/or the female portions 22, 24 adapted to engage with a component of the other portion. For example, as illustrated in FIG. 14, the male portion 22 may include a support sleeve 84 located on the outer edge of the base 26 and extending therefrom, wherein the support sleeve 84 may be adapted to engage with the exterior surface 58 of the female portion 24, which may include a notch 86 adapted to receive the support sleeve 84.

In another exemplary embodiment depicted in FIG. 15, the connector 20 may include one or more fittings 88. For example, the connector 20 may be adapted to connect with one or more portions of a device or object 90 having fittings 88, such as a pair of extension poles 90 having male and female threads 92, 94. As illustrated in FIG. 14, the male portion 22 of the connector 20 may include a fitting 88 in the form of an external thread which is able to engage with an internal thread of a first extension pole 90, and the female portion 24 of the connector 20 may include a fitting 88 in the form of an internal thread which is able to engage with an external thread of another extension pole 90.

In another exemplary embodiment depicted in FIG. 16, the connector 20 may include an inner strut member 98 from which the locking member 30 or the one or more lugs 44 extend. The inner strut member 98 may extend from the center of the base 26 along a central axis of the base 26, and may have a diameter equal to or greater than the guide rod 28. As illustrated in FIG. 16, the locking member 30 may be located at or near the end of the inner strut member 98, but in another embodiment, may be located anywhere along a length of the inner strut member 98. With the addition of the inner strut member 98, the locking shape of the male portion 22, as seen in FIG. 16, may include the guide rod 28, the lugs 44, and the strut member 98. Similarly, the aperture 62 of the corresponding female portion 24 may accommodate for the added size and shape of the inner strut member 98.

In another exemplary embodiment, the guide rod 28 may be constructed as a single unitary piece along with the male portion 22 or as a separate piece. If constructed as a separate piece, the guide rod 28 may be inserted into a guide rod cavity (not shown) in the male portion 22, and may be secured therein in a numbers of ways, including but not limited to, fasteners, such as screws and/or adhesive, a press-fit between the guide rod cavity and the guide rod, an interference-fit between the guide rod cavity and the guide rod 28, etc.

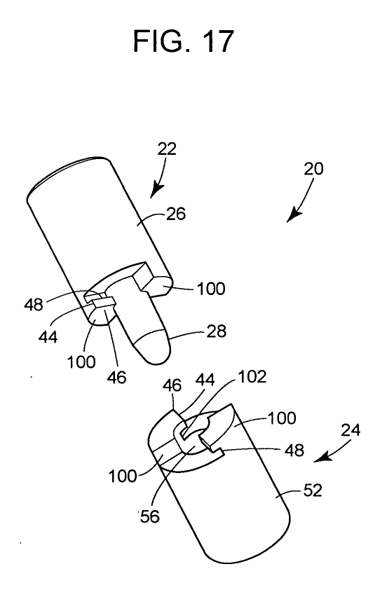

In another exemplary embodiment depicted in FIG. 17, the connector 20 may include a second configuration of the first and second locking members 30, 54, and may include a removable or separate guide rod 28. In this embodiment of the connector 20, the male portion 22 and the female portion 24 are substantially similar. The male and female portions 22, 24, as illustrated in FIG. 17, each include one or more lugs 44 extending outwardly from one or more outer strut members 100. The outer strut members 100 may extend from the mating surfaces 34, 60 of the bases 26, 52, and more specifically, may extend from the mating surfaces 34, 60 as annulus portions, wherein an outer diameter may be defined by the perimeter of the bases 26, 52 and an inner diameter may be defined by the guide rod 28 or the bore 56. The lugs 44 may extend outwardly from the outer strut members 100, and may continue the annulus portion such that the lower surfaces 48 of the lugs 44 are substantially perpendicular to the central axis of the bases 26, 52. The upper surfaces 46 of the lugs 44 may be a contiguous planar surface with a top of the outer strut member 100, and may also be perpendicular to the central axis of the bases 26, 52. Cavities 102, located between the lower surfaces 48 of the lugs 44 and the mating surfaces 34, 60 are adapted to receive the lugs 44 of the complimentary portions 22 or 24.

In this embodiment, the user may guide and align the male and female portions 22, 24 as with the other embodiments, and may connect the male and female portions 22, 24 by inserting the outer strut members 100 of the male portion 22 into the areas between the outer strut members 100 of the female portion 24 and vice-versa, such that the outer upper surfaces of the lugs 44 abut the mating surfaces 34, 60 of the male and female portions 22, 24 respectively. The lugs 44 may then be engaged by rotating the male and female portions 22, 24 relative to each other, and more specifically, in this embodiment may be rotated counter-clockwise relative to each other, such that the bottom surface 48 of the lugs 44 of the male portion 22 abut the bottom surface 48 of the lugs 44 of the female portion 24. A taper or incline located on the upper surfaces 46, the lower surfaces 48, and/or the mating surfaces 34, 60 may cause the lugs 44 to be locked in the cavities 102.

The connector 20 may be manufactured from a variety of materials and in a variety of ways. For example, the connector 20 may be manufactured from materials, including but not limited to, metals, plastics, composites, wood and fiberglass. Similarly, the method of manufacture may vary depending on the materials used. For example, when manufacturing the connector 20 from metal, a stock piece off raw material such as a rod or pipe may be cut into two portions, from which the male and female portions 22, 24 can then be cut and shaped. When manufacturing the connector 20 from plastic, however, the male and female portions 22, 24 may be molded using, for example, a blow molding, an injection molding, or pour molding process.

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

1. A connector comprising:
a first portion including a base having a mating surface, a first locking member having one or more outwardly protruding lugs, and a guide rod having an outer diameter; and
a second portion including a base having a mating surface and a first cavity, a second locking member including a second cavity, and a bore,
wherein the bore is adapted to receive the guide rod, and the cavity of the second member is adapted to receive the first locking member so that the base of the first portion and the base of the second portion are forced together during rotation of the first and second portions relative to each other when the first locking member is disposed in the cavity.

2. The connector of claim 1, wherein the lugs have a generally oval locking shape.

3. The connector of claim 1, further including at least one seal member.

4. The connector of claim 3, wherein the seal member is located on one of the mating surface of the first portion, the mating surface of the second portion, the guide rod of the first portion and the third cavity of the second portion.

5. The connector of claim 1, wherein an outer diameter of the guide rod and an inner diameter of the bore are tightly toleranced.

6. The connector of claim 5, wherein a gap and tolerance between the outer diameter of the guide rod and the inner diameter of the bore is in the range of 0.0005^{+0.0002-0.0000}.

7. The connector of claim 1, further including a passageway disposed in the guide rod adapted to allow the passage of fluid through the connector.

8. The connector of claim 1 further including a support sleeve.

9. The connector of claim 1, wherein at least one of the one or more lugs includes a lower surface and an upper surface.

10. The connector of claim 9, wherein the upper and lower surfaces are parallel.

11. The connector of claim 9, wherein one of the surfaces is parallel to the mating surface and the other surface has a semi-spiral shape.

12. The connector of claim 1, wherein the second cavity includes a surface having a semi-spiral shape, adapted to engage with the lugs.

13. The connector of claim 1, further including an exterior surface on the base of the first portion and an exterior surface on the base of the second portion, wherein the exterior surface on the base of the first portion is contiguous with the exterior surface on the base of the second portion when the first and second portions are securely engaged.

14. A connector comprising:
a first portion having a base, a first locking member and a guide rod, the first locking member being located along the guide rod,
the base including a mating surface,
the first locking member including a plurality of outwardly protruding lugs having upper and lower surfaces, the lugs combining to create a locking shape, and
the guide rod having a first end, a second end and an outer diameter; and
a second portion having a base, a bore and a second locking member, the second locking member being located along the bore,
the base of the second portion including a mating surface adapted to abut the mating surface of the base of the first portion, and an aperture adapted to compliment the locking shape of the lugs,
the second locking member including a cavity and a first lug surface, wherein the cavity is adapted to receive and allow for the rotation of the lugs, such that the first surface of the first locking member contacts the lug surface, and
the bore having a first end, a second end and an inner diameter adapted to receive the guide rod;
one of the lug surfaces of the second locking member and the lower surface of the lugs being angled, thereby forcing the mating surfaces of the bases together during rotation of the first and second portions relative to each other.

15. The connector of claim 14, wherein the locking shape is oval.

16. The connector of claim 14, further including at least one seal member.

17. The connector of claim 16, wherein the seal member is located on one of the mating surface of the first portion, the mating surface of the second portion, the guide rod of the first portion and the third cavity of the second portion.

18. The connector of claim 14, wherein a gap between the outer diameter of the guide rod and the inner diameter of the bore is tightly toleranced.

19. The connector of claim 18, wherein the gap and tolerance is in the range of 0.0005^{+0.0002-0.0000}.

20. The connector of claim 14, further including a passageway deposited in the guide rod adapted to allow the passage of fluid through the connector.

21. The connector of claim 14, further including a support sleeve.

22. The connector of claim 14, wherein the upper and lower surfaces of the lugs are parallel.

23. The connector of claim 14, wherein the first portion and the second portions of the connector have a contiguous exterior surface.

24. The connector of claim 14, wherein the lugs extend from the guide rod.

25. The connector of claim 14, wherein the lugs extend from the base of the first portion.

26. The connector of claim 14, wherein the distance between the upper and lower lug surfaces changes from less than to greater than the distance between the lower surface of the lug and the mating surface of one of the first portion and the second portion.

27. The connector of claim 14, wherein the distance between the upper and lower lug surfaces changes from less than to greater than, the distance between the first and a second lug surface of the cavity.

28. The connector of claim 14, wherein the distance between the first and a second lug surfaces changes from greater than to less than, the distance between the upper and lower lug surfaces.

29. A method of operation for a connector comprising:
providing a first portion, including a base having a mating surface, a first locking member having a plurality of outwardly protruding lugs, the lugs combining to create a locking shape, and a guide rod having an outer diameter,
providing a second portion including a base having a mating surface and an aperture, a second locking member having a cavity, and a bore;
inserting the guide rod into the bore for alignment of the first and second portions relative to each other;
aligning the locking shape with the aperture;
inserting the lugs into the cavity; and
engaging the first and second locking members by rotating the first portion with respect to the second portion.

30. The method of claim 29 further including compressing a seal member between the first and second portions.

31. The method of claim 29 further including rotating the locking shape relative to the aperture.

32. The method of claim 29 further including compressing a seal member.

33. A method of manufacture for a connector comprising:
creating a first portion including a base having a mating surface, a first locking member having one or more outwardly protruding lugs, the one or more lugs having a locking shape, and a guide rod having an outer diameter;
creating a second portion including a base having a mating surface and a first cavity, a second locking member including a second cavity, and a bore, wherein bore is adapted to receive the guide rod, and the cavity of the second member is adapted to receive the first locking member so that the base of the first portion and the base of the second portion are forced together during rotation of the first and second portions relative to each other when the first locking member is disposed in the cavity.

34. The method of claim 33, further including making the locking shape oval.

35. The method of claim 33, further including placing at least one seal member on the connector.

36. The method of claim 35, further including locating the at least one seal member on one of the mating surface of the first portion, the mating surface of the second portion, the guide rod of the first portion and the third cavity of the second portion.

37. The method of claim 33, further including tightly tolerancing a gap between the outer diameter of the guide rod and an inner diameter of the bore.

38. The method of claim 33, further including creating a passageway in the guide rod adapted to allow the passage of fluid through the connector.

39. The method of claim 33, further including creating a support sleeve.
